(19) United States
(12) Patent Application Publication
(10) Pub. No.: US 2009/0246475 A1
(43) Pub. Date: Oct. 1, 2009

(54) DECORATIVE FILM FOR MOLDING

(75) Inventors: Shinnosuke HIRATA, Saitama (JP); Kazuhiro Suga, Saitama (JP); Junko Kashiwagi, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Dai Nippon Printing Co., Ltd.

(21) Appl. No.: 12/412,560

(22) Filed: Mar. 27, 2009

(30) Foreign Application Priority Data
Mar. 28, 2008 (JP) 085724/2008

(51) Int. Cl. B32B 3/00

(52) U.S. Cl. 428/172

(57) ABSTRACT

A decorative film for molding having bossed portions on a base sheet, wherein the area of the entire bossed portions is 45% or smaller of the area of the entire face of the base sheet, and the area of a single bossed portion is 2 mm² or smaller. No cracks are formed on the pattern having elevations and depressions on the surface of the decorative film for molding during vacuum forming or injection molding in the insert molding or during injection molding in the thermoject molding.

### TECHNICAL FIELD

The present invention relates to a decorative film for molding used in the insert molding or the thermoject molding.

### BACKGROUND ART

Heretofore, decorative molded articles having decorated faces on molded articles of resins have been used in various applications. For example, in Patent Reference 1, a process for producing a molded article in which a molded article having the surface coated with a sheet is produced by injection molding of a resin for molding after a decorative sheet for molding laminated with a backer layer is formed on the inner face of a mold, i.e., a process for producing a molded article in accordance with the insert molding process, is proposed.

In the insert molding process, in general, the pattern to be formed on the decorative film for molding is formed as a flat pattern in accordance with the gravure printing process or the like using a thermoplastic resin such as an acrylic resin as the binder. The pattern is formed on the back face (at the side having the molded article of a resin) of the base sheet so that the pattern exhibits durability (such as wear resistance). As the result, the surface of the obtained insert molded article has a flat appearance having uniform gloss, and the feel of a design having elevations and depressions cannot be obtained on the surfaces of the molded article without further treatments. The same problem is found in the thermoject molding.

To overcome the above problem, it is attempted that a pattern is printed on the back face of the base sheet and the surface is provided with elevations and depressions by the embossing (pressing the pattern) of the front face of the base sheet so that the feel having elevations and depressions, the steric feel and the feel of depth are provided to the surface of the molded article. However, when the surface having elevations and depressions is formed by the embossing, the surface having elevations and depressions is occasionally reduced to a flat surface due to the effect of heat and force during the injection molding or the preliminary forming (the vacuum forming) before the injection molding, or the elevations and depressions are occasionally easily erased or damaged due to wear since the surface having elevations and depressions is formed with a thermoplastic resin.

In Patent Reference 2, an invention in which the thermoject molding (the decorating injection molding) is conducted using a decorative sheet having pattern layers of a resin formed with a cured product of a resin curable with an ionizing radiation on portions of the sheet, is disclosed. In Patent Reference 3, a process for producing an insert sheet having patterns having fine elevations and depressions in which a surface protective layer made of an uncured resin of the ionizing radiation curing type is formed on a base sheet, the face at the side having the surface protective layer is shaped with the face of a mold for embossing having fine elevations and depressions under application of heat and pressure and, then, the surface protective layer having the pattern having fine elevations and depressions is cured by irradiation with an ionizing radiation, is proposed.

In Patent Reference 4, an insert sheet having elevations and depressions which is obtained by filling depressions on an engraved plate having fine elevations and depressions on the surface with an uncured resin of the ionizing radiation curing type, and applying the ionizing radiation while a base sheet is pressed to the face of the engraved plate to form a cured layer having fine elevations and depressions having a thickness of 2 μm or greater on one face of the base sheet, is proposed.

However, the above sheet has a problem in that cracks are formed on the pattern having elevations and depressions on the surface of the sheet during the vacuum forming or the injection molding when the insert molding is conducted using the sheet or during the injection molding when the thermoject molding is conducted using the sheet.

[Patent Reference 1] Japanese Patent Application Publication No. Heisei 8(1996)-2550

[Patent Reference 2] Japanese Patent Application Laid-Open No. 2002-240078

[Patent Reference 3] Japanese Patent Application Laid-Open No. 2004-42409

[Patent Reference 4] Japanese Patent Application Laid-Open No. 2004-276416

### DISCLOSURE OF THE INVENTION

The present invention has an object of providing a decorative film for molding which prevents formation of cracks on a pattern having elevations and depressions on the decorative film during vacuum forming or injection molding in the insert molding or during injection molding in the thermoject molding.

As the result of intensive studies to achieve the above object by the present inventors, it was found that the above object could be achieved by improving the arrangement and the size of the bossed portions forming the pattern having elevations and depressions on the surface of the decorative film for molding. The present invention has been completed based on the knowledge.

The present invention provides:
[1] A decorative film for molding having bossed portions on a base sheet, wherein an area of an entire bossed portions is 45% or smaller of an area of an entire face of the base sheet, and an area of a single bossed portion is 2 mm² or smaller;
[2] A decorative film for molding described in [1], wherein a distance between bossed portions is 0.2 mm or greater;
[3] A decorative film for molding described in any one of [1] and [2], wherein the bossed portions are formed with a cured product obtained by crosslinking a resin composition curable with an ionizing radiation; and
[4] A decorative film for molding described in any one of [1], [2] and [3], which is obtained by laminating a colored layer, an adhesive layer and a backer layer to a back face of the base sheet successively in this order.

In accordance with the present invention, the decorative film for molding which prevents formation of cracks on a pattern having elevations and depressions on the decorative film during vacuum forming or injection molding in the insert molding or during injection molding in the thermoject molding can be provided.

### BRIEF DESCRIPTION OF THE DRAWINGS

FIG. 1 shows a schematic diagram exhibiting a sectional view of an embodiment of the decorative film for molding of the present invention.

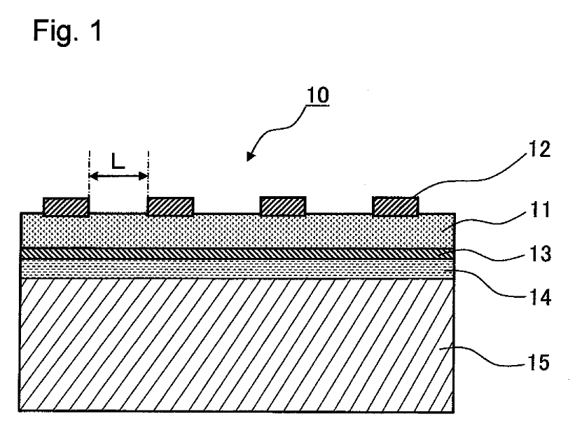

In FIG. 1, reference numerals mean as follows:

10: A decorative film for molding

11: A base sheet

12: A bossed portion

13: A colored portion

14: An adhesive layer

15: A backer layer

### THE MOST PREFERRED EMBODIMENT TO CARRY OUT THE INVENTION

The present invention will be described with reference to a figure. FIG. 1 shows a schematic diagram exhibiting a sectional view of an embodiment of the decorative film for molding of the present invention.

The decorative film for molding of the present invention 10 (hereinafter, referred to briefly as a decorative film 10, occasionally) is characterized in that the decorative film 10 has bossed portions 12 on a base sheet 11, the area of the entire bossed portions 12 is 45% or smaller of the area of the entire face of the base sheet 11, and the area of a single bossed portion is 2 mm² or smaller. The area of the entire bossed portions 12 is set at 45% or smaller of the area of the entire face of the base sheet 11 so that individual bossed portions are not excessively close to each other. From this standpoint, it is preferable that the area of the entire bossed portions 12 is 40% or smaller. Although the area of the entire bossed portions 12 has no lower limit, it is preferable that the area of the entire bossed portions 12 is 1% or greater since it is difficult to visually recognize that the decorative film has a pattern having elevations and depressions when the entire bossed portions 12 is excessively small. It is required that the area of a single bossed portion be 2 mm² or smaller so that concentration of stress at specific bossed portions 12 is prevented. Although the area of a single bossed portion has no lower limit, it is preferable that the area of a single bossed portion 12 is 0.01 mm² or greater since it is difficult to visually recognize that the decorative film has a pattern having elevations and depressions when the area of the a single bossed portion 12 is excessively small.

Formation of cracks on the pattern having elevations and depressions on the surface of the decorative film 10 can be prevented during the vacuum forming or the injection molding in the insert molding or during the injection molding in the thermoject molding (hereinafter, referred to as “during the decorative molding”, occasionally) by limiting the area of the entire bossed portions 12 and the area of a single bossed portion 12 as described above.

Formation of cracks on the pattern having elevations and depressions on the surface of the decorative film 10 can be prevented more suitably by adjusting the distance between bossed portions 12L at 0.2 mm or greater. From this standpoint, it is more preferable that the distance between bossed portions 12 is adjusted at 0.4 mm or greater The distance between bossed portions 12L means the smallest distance between end portions of individual bossed portions 12 as shown in FIG. 1.

In the decorative film 10 of the present invention, the shape of the individual bossed portion 12 on the base material 11 is not particularly limited and may be the same shape or a group of different shapes selected from circular shapes, elliptical shapes, trigonal shapes, tetragonal shapes and pentagonal to decagonal shapes. The pattern may be a regular pattern in which the bossed portions 12 are regularly arranged or an irregular pattern in which the bossed portions 12 are irregularly arranged. The irregular pattern is preferable from the standpoint that excellent feel of contact, feel of a mat, feel of the gloss and property for designing are exhibited. The regular pattern in which the bossed portions are regularly arranged is preferable from the standpoint that the concentration of stress at specific portions during the molding to form the decorative pattern can be suppressed, and the formation of cracks on the pattern having elevations and depressions on the surface is more effectively suppressed.

It is more preferable that the longest portion in the shape of the individual bossed portions 12 is 1.5 mm or smaller.

As the pattern, one or more types of patterns selected from geometrical patterns such as circular patterns, elliptical patterns, polygonal patterns, line drawing patterns, dot patterns, stripe patterns and grid patterns, character patterns, wood grain patterns, bamboo grain patterns, stone grain patterns, assembled tile patterns, brick layer patterns, texture patterns and leather spot patterns can be used in accordance with the application.

In the insert molding, it is preferable that the decorative film 10 is formed by laminating a colored layer 13, an adhesive layer 14 and a backer layer 15 successively in this order on the back face of the base sheet 11 opposite to the face having the bossed portions 12 as shown in FIG. 1.

On the other hand, in the thermoject molding, in general, no back layer 15 is laminated to the decorative film 10.

As the base sheet 11 used for the decorative film 10 of the present invention, a sheet of a thermoplastic resin is advantageously used since the excellent property for molding can be obtained easily when the decorative film 10 is used by molding. As the thermoplastic resin used for the base sheet 11, acrylic resins, vinyl chloride resins, ABS resins (acrylonitrile-styrene-butadiene copolymers), styrene resins, poly-carbonate resins, polyester resins such as polyethylene terephthalate and moldable polyester resins and polyolefin-based resins such as polyethylene, polypropylene, polymethylpentene, polybutene, ethylene-propylene copolymers, propylene-butene copolymers and olefin-based thermoplastic elastomers are preferable.

Among the above thermoplastic resins, acrylic resins and moldable polyester resins are more preferable.

As the acrylic resin, for example, polymethyl (meth)acrylate, polybutyl (meth)acrylate, methyl (meth)acrylate-butyl (meth)acrylate copolymers and methyl (meth)acrylate-styrene copolymers are used singly or as a mixture of two or more. (Meth)acrylate means acrylate or methacrylate.

As the moldable polyester resin, polyester-based thermoplastic elastomers and amorphous polyesters can be used. Examples of the polyester-based thermoplastic elastomer include block copolymers using a highly crystalline aromatic polyester having a high melting point as the hard segment and an amorphous polyether having a glass transition temperature of −70° C. or lower as the soft segment. As the highly crystalline aromatic polyester having a high melting point, for example, polybutylene terephthalate is used. As the amorphous polyether, for example, polytetramethylene glycol is used. Typical examples of the amorphous polyester include ethylene glycol-1,4-cyclohexanedimethanol terephthalate copolymers.

As the base sheet 11, for example, a resin sheet having a single layer structure or a multi-layer structure comprising the resins described above is used. To the base sheet 11, where necessary, various additives such as stabilizers, plasticizers, coloring agents, ultraviolet light absorbents, hindered amine light stabilizers and fillers may be suitably added to adjust the physical properties. When the base sheet 11 is colored, the coloring may be transparent or not transparent. When a colored layer for a visual pattern is formed on the back face of the base sheet 11, the base sheet is made transparent to a degree such that the colored layer is visible. For the coloring, for example, conventional coloring agents such as those described below for the colored layer can be used.

The thickness of the base sheet 11 is not particularly limited. It is preferable that the thickness (the thickness of the entire sheet when the base sheet has a plurality of layers) is, in general, about 30 to 300 μm from the standpoint of the cost, the properties required for the article obtained by the insert molding or the thermoject molding and the properties for molding of the decorative film for molding.

Where necessary, the front face, the back face or both of the front face and the back face of the base sheet 11 may be suitably treated by a conventional treatment for enhancing adhesion such as the corona discharge treatment, the plasma treatment and the formation of a primer layer with a urethane resin or the like so that adhesion with other layers brought into contact with the base sheet 11 is enhanced.

It is preferable that the bossed portion 12 arranged on the decorative film 10 of the present invention is a cured product obtained by crosslinking a resin composition curable with an ionizing radiation. The cured product is used for improving durability such as wear resistance of the bossed portions and, in particular, for preventing the bossed portions from being erased or damaged early due to wear. As the resin curable with an ionizing radiation used for the resin composition curable with an ionizing radiation, a suitable resin curable by crosslinking with an ionizing radiation such as ultraviolet light, visible light and electron beam can be used in accordance with the application.

As the resin curable with an ionizing radiation, specifically, compositions curable with an ionizing radiation obtained by suitably mixing prepolymers (including so-called oligomers) and/or monomers having a radical polymerizable unsaturated bond or a cationic polymerizable functional group in the molecule are preferably used. The prepolymer and the monomer may be used singly or as a mixture of two or more.

Specifically, examples of the prepolymer and the monomer described above include compounds having a radical polymerizable unsaturated group such as (meth)acryloyl group and (meth)acryloyloxy group or a cationic polymerizable functional group such as epoxy group in the molecule. Polyene/thiol-based prepolymers as combinations of a polyene and a polythiol are also preferable. (Meth)acryloyl group means acryloyl group or methacryloyl group. Examples of the prepolymer having a radical polymerizable unsaturated group include polyester (meth)acrylate-based prepolymers, urethane (meth)acrylate-based prepolymers, epoxy (meth)acrylate-based prepolymers, polyether (meth)acrylate-based prepolymers, melamine (meth)acrylate-based prepolymers, triazine (meth)acrylate-based prepolymers and silicone (meth)acrylate-based prepolymers. As for the molecular weight, in general, compounds having a molecular weight of about 250 to 100,000 are used.

The epoxy (meth)acrylate-based prepolymer can be obtained, for example, by esterification of oxirane ring in an epoxy resin of the bisphenol type or an epoxy resin of the novolak type having a relatively low molecular weight by the reaction with (meth)acrylic acid. Epoxy (meth)acrylate prepolymers of the carboxyl modification type obtained by partially modifying the above epoxy (meth)acrylate-based oligomer with an anhydride of a dibasic carboxylic acid can also be used. The urethane (meth)acrylate-based prepolymer can be obtained, for example, by obtaining a polyurethane prepolymer by the reaction of a polyether polyol or a polyester polyol with a polyisocyanate, followed by esterification of the obtained polyurethane prepolymer with (meth)acrylic acid. The polyester (meth)acrylate-based prepolymer can be obtained, for example, by obtaining a polyester prepolymer having hydroxyl group at both ends by condensation of a polybasic carboxylic acid with a polyhydric alcohol, followed by esterification of hydroxyl group at the ends in the obtained polyester prepolymer with (meth)acrylic acid or by obtaining a prepolymer having hydroxyl group at the ends by addition of an alkylene oxide to a polybasic carboxylic acid, followed by esterification of hydroxyl group at the ends in the obtained prepolymer with (meth)acrylic acid. The polyether (meth)acrylate-based prepolymer can be obtained by esterification of hydroxyl group in a polyether polyol with (meth)acrylic acid.

Further examples of the polymerizable prepolymer include polybutadiene (meth)acrylate-based prepolymers exhibiting great hydrophobic property which have (meth)acrylate group at side chains of polybutadiene oligomers, silicone (meth)acrylate-based prepolymers having polysiloxane bond in the main chain, aminoplast resin (meth)acrylate-based prepolymers obtained by modifying aminoplast resins having many reactive groups in small molecules and prepolymers having a cationic polymerizable group in the molecule such as novolak-type epoxy resins, bisphenol-type epoxy resins, aliphatic vinyl ethers and aromatic vinyl ethers.

As the monomer having a radical polymerizable unsaturated group, for example, (meth)acrylate-based monomers having a radical polymerizable unsaturated group in the molecule are preferable, and polyfunctional (meth)acrylates are more preferable. “(Meth)acrylate” means “acrylate or methacrylate”. The polyfunctional (meth)acrylate is not particularly limited as long as the polyfunctional (meth)acrylate is a (meth)acrylate having two or more ethylenically unsaturated bonds in the molecule. Examples of the polyfunctional (meth)acrylate include ethylene glycol di(meth)acrylate, propylene glycol di(meth)acrylate, 1,4-butanediol di(meth)acrylate, 1,6-hexanediol di(meth)acrylate, neopentyl glycol di(meth)acrylate, polyethylene glycol di(meth)acrylate, neopentyl glycol hydroxypivalate di(meth)acrylate, dicyclopentanyl di(meth)acrylate, dicyclopentenyl di(meth)acrylate modified with caprolactone, phosphoric acid di(meth)acrylate modified with ethylene oxide, cyclohexyl di(meth)acrylate modified with allyl group, isocyanurate di(meth)acrylate, trimethylolpropane tri(meth)acrylate, trimethylol-propane tri(meth)acrylate modified with ethylene oxide, dipentaerythritol tri(meth)acrylate, dipentaerythritol tri(meth)acrylate modified with propionic acid, pentaerythritol tri(meth)acrylate, trimethylolpropane tri(meth)acrylate modified with propylene oxide, tris(acryloxyethyl) isocyanurate, dipentaerythritol penta(meth)acrylate modified with propionic acid, dipentaerythritol hexa(meth)acrylate, dipentaerythritol hexa(meth)acrylate modified with ethylene oxide and dipentaerythritol hexa(meth)acrylate modified with caprolactone. The polyfunctional (meth)acrylates may be used singly or in combination of two or more.

In the present invention, monofunctional (meth)acrylates may be suitably used in combination with the prepolymers and the polyfunctional (meth)acrylates described above for decreasing the viscosity as long as the object of the present invention is not adversely affected. Examples of the monofunctional (meth)acrylate include methyl (meth)acrylate, ethyl (meth)acrylate, propyl (meth)acrylate, butyl (meth)acrylate, pentyl (meth)acrylate, hexyl (meth)acrylate, cyclohexyl (meth)acrylate, 2-ethylhexyl (meth)acrylate, lauryl (meth)acrylate, stearyl (meth)acrylate, isobornyl (meth)acrylate and phenoxyethyl (meth)acrylate. The monofunctional (meth)acrylate may be used singly or in combination of two or more.

When the curing is conducted by irradiation with ultraviolet light or visible light, a photopolymerization initiator is further added into the resin composition curable with an ionizing radiation described above. In the case of the resin system having a radical polymerizable unsaturated group, acetophenones, benzophenones, thioxanthones, benzoins or benzoin methyl ethers can be used singly or as a mixture as the photo-polymerization initiator. In the case of the resin system having a cationic polymerizable functional group, aromatic diazonium salts, aromatic sulfonium salts, aromatic iodonium salts, metallocene compounds or benzoinsulfonic acid esters can be used singly or as a mixture as the photopolymerization initiator. The amount of the photopolymerization initiator is about 0.1 to 10 parts by mass per 100 parts by mass of the resin curable with an ionizing radiation.

To the resin composition curable with an ionizing radiation, thermoplastic resins such as vinyl chloride-vinyl acetate copolymers, polyvinyl acetate, acrylic resins and cellulose-based resins may be added, where necessary. Where necessary, various additives may be added to the above resin composition curable with an ionizing radiation. For example, particles comprising inorganic compounds such as silica, alumina, calcium carbonate, aluminosilicate and barium sulfate, or organic macromolecules such as polyethylene, urethane resins, polycarbonates and polyamides (nylon) may be added as the delustering agent or a filler. The average diameter of the particles used above is about 1 to 10 μm, and the amount of the addition is about 5 to 30% by mass. The shape of the particles is a polygonal shape, a spherical shape or a flake shape.

The bossed portion 12 arranged on the decorative film 10 of the present invention can be formed on the base sheet 11 with a liquid composition which is the resin composition curable with an ionizing radiation described above in accordance with a conventional process of formation such as a printing process, examples of which include the silk screen printing process, the gravure boss printing process and the forming cylinder process described in Patent Reference 2, and a coating process. The thickness of the bossed portion is not particularly limited and is, in general, about 1 to 200 μm. When the feel having elevations and depressions and the steric feel are emphasized for vision, it is preferable that the bossed portion has a thickness of 10 μm or greater.

As the ionizing radiation, electromagnetic wave or charged particles having an energy which can induce the curing reaction in the molecules of the resin composition curable with ionizing radiation is used. In general, ultraviolet light or electron beam is used. Visual light, X-ray or ion beam can also be used. As the source of ultraviolet light, a light source such as an ultra high voltage mercury lamp, a high voltage mercury lamp, a low voltage mercury lamp, a carbon arc lamp, a black light and a metal halide lamp is used. As the ultraviolet light, light having a wavelength in the range of 190 to 380 nm is mainly used. As the source of the electron beam, sources emitting electrons having energy of 100 to 1,000 keV and preferably 100 to 300 keV using various types of electron beam accelerators such as electron beam accelerators of the Cockcroft-Walton type, the Van de Graaff type, the resonance transformer type, the insulating core transformer type, the linear type, the dynamitron type and the high frequency type are used.

The colored layer 13 laminated to the back face of the decorative film 10 of the present invention where desired comprises a patterned layer and/or a hiding layer. The pattern on the patterned layer can be selected as desired. For example, patterns such as wood grain patterns, stone grain patterns, texture patterns, sand patterns, leather spot patterns, assembled tile patterns, brick layer patterns, geometrical patterns, characters, symbols and solid patterns covering the entire face are used in accordance with the application singly or in combination of two or more. The hiding layer is, in general, a solid layer covering the entire face.

The ink for forming the colored layer 13 comprises a vehicle comprising a binder, coloring agents such as pigments and dyes and various additives suitably added to the above components. As the resin used for the binder, for example, a single resin or a mixture of resins selected from acrylic resins, vinyl chloride-vinyl acetate copolymers, polyester resins, cellulose-based resins, chlorinated polypropylene, urethane resins and polyamide resins is used.

As the coloring agent, for example, inorganic pigments such as white titanium, zinc oxide, carbon black, iron black, iron oxide red, chrome vermilion, cadmium red, ultramarine, cobalt blue, chrome yellow and titanium yellow; organic pigments (including dyes) such as phthalocyanine blue, indanthrene blue, isoindolinone yellow, benzidine yellow, quinacridone red, polyazo red and perylene red; metal pigments comprising flake-shaped powder of foils of aluminum or brass, and pearl pigments comprising flakes of mica coated with titanium dioxide or basic lead carbonate are used.

The colored layer 13 can be formed in accordance with a conventional process, examples of which include conventional printing processes such as the gravure printing process, the silk printing process and the offset printing process and conventional coating processes such as the roll coating process.

The thickness of the colored layer 13 is not particularly limited and is, in general, about 0.5 to 20 μm.

In the present invention, where necessary, an adhesive layer 14 may be suitably formed on the back face of the base sheet 11 or the colored layer 13 so that adhesion between the base sheet 11 or the colored layer 13 and the backer layer 15 or an injected resin is enhanced. The material of the adhesive layer 14 is selected from wide range of resins exhibiting excellent adhesion with the colored layer 13, properties suitable for printing and properties suitable for molding. Specifically, it is preferable that the resin is selected from urethane resins of the two-component curing type using a blocked isocyanate as the curing agent, chlorinated polyolefins such as chlorinated polypropylene, (meth)acrylic resins, vinyl chloride-vinyl acetate copolymers and mixtures of (meth)acrylic resins and vinyl chloride-vinyl acetate copolymers. As the (meth)acrylic resins and the vinyl chloride-vinyl acetate copolymers used for the adhesive layer 14, the (meth)acrylic resins and the vinyl chloride-vinyl acetate copolymers described above for the colored layer 13 can be used. When the backer layer 15 or the injected resin is an ABS resin or a polyolefin resin, urethane resins of the two-component curing type using a blocked isocyanate as the curing agent and chlorinated polyolefins such as chlorinated polypropylene are preferable for the adhesive layer 14.

In the adhesive layer 14, resins other than the resins described above may be used in combination as long as the other resins are used as auxiliary components. The resins used in combination are selected mainly with consideration on adhesion with the injected resin. Where necessary, various conventional additives such as fillers and stabilizers for storage may be suitably added so that various properties such as the property for printing (or coating) are adjusted and improved.

The adhesive layer 14 is formed with the adhesive comprising the above resin and other components in accordance with a conventional printing or coating process such as the gravure printing process and the roll coating process. The thickness of the adhesive layer is not particularly limited and is, in general, about 1 to 50 μm.

As the material for the backer layer 15 laminated to the back face of the adhesive layer 14 of the decorative film 10 of the present invention where desired, ABS resins, polyolefin resins, styrene resins, (meth)acrylic resins, vinyl chloride resins and polycarbonate resins are preferable. As the polyolefin resins, polypropylene resins are preferable. Among the above resins, ABS resins and polypropylene resins are more preferable. When the injected resin is a polypropylene resin, polypropylene resins are preferable. Since the backer layer 15 is laminated to reinforce the decorative film 10 and maintain the shape of the integrally formed article, a sheet having a thickness of about 0.1 to 0.5 mm is used.

As for the process for producing the decorative film 10 of the present invention, for example, the colored layer 13 and the adhesive layer 14 are laminated successively to the base sheet 11 in accordance with a conventional means of printing or coating such as the gravure printing process or the roll coating process and, thereafter, the backer layer 15 is dry laminated. When the colored layer 13 comprises a plurality of layers, the layer having patterns is laminated and dried and, thereafter, the hiding layer and other layers are laminated. In the decorative film 10 of the present invention, it is preferable that, after the backer layer 15 has been dry laminated, the bossed portions 12 are formed on the face of the base sheet opposite to the face having the backer layer 15 in accordance with the process described above.

The process for producing an insert molded article using the decorative film 10 of the present invention will be described in the following. The decorative film 10 of the present invention produced as described above is formed into a specific shape in accordance with the vacuum forming process.

The decorative film 10 fixed to a fixing frame is heated by a heater to a specific temperature at which the decorative film is softened. A mold for vacuum forming is pressed to the decorative film 10 softened by the heating and, at the same time, the decorative film 10 is brought into tight contact with the mold for vacuum forming by sucking the air from the mold for vacuum forming by a vacuum pump or the like.

After the decorative film 10 has been brought into tight contact with the mold for vacuum forming, the decorative film 10 is cooled. The mold for vacuum forming is removed from the formed decorative film 10, and the formed decorative film 10 is separated from the fixing frame. The vacuum forming is conducted, in general, at about 160 to 180° C.

Then, the decorative film 10 formed by the vacuum forming is treated by trimming away unnecessary portions, where desired, and fixed to a mold for injection molding. The resin for injection is injected to the back face (the face at the side of the backer layer 15, i.e., at the side of the lower face in FIG. 1) of the decorative film 10. In the final step, the product is taken out of the mold for injection molding, and the insert molded article is obtained. It is sufficient that the injection molding is conducted at a temperature of the melting point of the resin for injection or higher. For example, the temperature of the injection molding is about 180 to 210° C. in the case of polypropylene-based resins and about 220 to 260° C. in the case of ABS resins and PCABS resins.

When an article is produced in accordance with the thermoject molding using the decorative film 10 of the present invention, after the decorative film 10 is fixed to a mold for injection molding, the vacuum forming is conducted where desired and, thereafter, the decorating injection molding is conducted by injecting the resin. The injection molding is conducted, in general, at about 200 to 260° C.

### EXAMPLES

The present invention will be described more specifically with reference to examples in the following. However, the present invention is not limited to the examples.

The presence or the absence of cracks on the surface of a decorative film for molding was examined in accordance with the following method.

### <Examination of the Presence or the Absence of Cracks on the Surface of a Decorative Film for Molding>

The presence or the absence of cracks on the pattern having elevations and depressions on the surface of a decorative film for molding was examined by visual observation, and the result was expressed in accordance with the following criterion:

excellent: no cracks found at all on the surface of the decorative film for molding obtained after the vacuum forming or on the surface of the molded article obtained after the injection molding

good: fine cracks found on the surface of the decorative film for molding obtained after the vacuum forming or on the surface of the molded article obtained after the injection molding, but no problems for practical application

poor: marked cracks found on the surface of the decorative film for molding obtained after the vacuum forming and on the surface of the molded article obtained after the injection molding, to decrease the commercial value of the molded article

### Examples 1 to 3 and Comparative Example 1

On the back face of a base sheet which was a non-colored transparent sheet of an acrylic resin containing polymethyl methacrylate as the main component and having a thickness of 75 μm, a patterned layer (the thickness: 1 μm) comprising polybutyl methacrylate/a vinyl chloride-vinyl acetate copolymer (the ratio of the amounts by mass: 2/1), a hiding layer (the thickness: 2 μm) comprising a mixture of polymethyl methacrylate and polybutyl methacrylate and inorganic pigments and an adhesive layer (the thickness: 10 μm) comprising a urethane resin-based adhesive of the two-component curing type were successively laminated. Then, after a backer layer (the thickness: 400 μm) comprising an ABS resin was laminated in accordance with the dry lamination, a resin composition curable with an ionizing radiation (the non-solvent type) which comprised 29 parts by mass of a urethane acrylate prepolymer, 6 parts by mass of polyethylene glycol diacrylate, 8 parts by mass of ethylcarbitol acrylate, 7 parts by mass of 2-ethylhexyl acrylate, 4 parts by mass of silicone acrylate, 2 parts by mass of a photopolymerization initiator (methylbenzoyl formate) and a suitable amount of a solvent (isopropyl alcohol) was printed on the formed laminate in accordance with the gravure printing process to form a pattern having a planar view in which many circular bossed portions were arranged. The resin composition was irradiated with ultraviolet light under the condition of 160 W/cm to cure the resin composition by crosslinking while the shape of the pattern formed in accordance with the gravure printing process was maintained, and bossed portions 12 elevated on the base sheet to a thickness of 30 μm were formed. In this manner, four types of the decorative films for molding were obtained. A single bossed portion 12 had a circular shape having a diameter of 1.0 mm. The area of the entire bossed portions relative to the area of the entire face of the base material (%), the area of the upper portion of a single bossed portion (mm²) and the distance between bossed portions (mm) were as shown in Table 1.

Then, the four types of the decorative films for molding were each fixed to a fixing frame and heated until the temperature of the decorative film for molding was elevated to about 160° C. by a heater of about 300° C. The decorative films for molding softened by the heating were treated in the step of vacuum forming, the step of trimming and the step of injection molding at a temperature of about 240° C. using an ABS resin as the resin for injection, and four types of the insert molded articles were obtained.

The presence or the absence of cracks on the patterns having elevations and depressions of the four types of the decorative films for molding obtained after the vacuum forming and on the four types of the molded articles obtained after the injection molding was examined. The results are shown in Table 1.

TABLE 1

| | Example | | | Comparative |
|---|---|---|---|---|
| | 1 | 2 | 3 | Example 1 |
| Bossed portion | | | | |
| area of entire bossed | 40 | 45 | 45 | 60 |
| portions relative to | | | | |
| entire area of surface (%) | | | | |
| area of single bossed | 0.6 | 0.8 | 2.0 | 4.0 |
| portion (mm²) | | | | |
| distance between bossed | 0.4 | 0.4 | 2.0 | 2.0 |
| portions (mm) | | | | |
| Result of evaluation | | | | |
| presence or absence of | excellent | excellent | good | poor |
| cracks | | | | |

As shown by the results in Table 1, the decorative films for molding of Examples 1 and 2 were excellent with no formation of cracks at all on the surface of the decorative films for molding obtained after the vacuum forming and on the surface of the molded articles obtained after the injection molding. The decorative film for molding of Example 3 showed fine cracks on the surface of the decorative films for molding obtained after the vacuum forming and on the surface of the molded articles obtained after the injection molding. However, the cracks were not marked, and there were no problems for the practical application.

In contrast, the decorative film for molding of Comparative Example 1 showed marked formation of cracks on the surface of the decorative film for molding obtained after the vacuum forming and on the surface of the molded article obtained after the injection molding, and the commercial value of the molded article decreased.

### INDUSTRIAL APPLICABILITY

When the decorative film for molding of the present invention is used, no cracks are formed on the surface of the decorative film for molding or on the pattern having elevations and depressions of the insert molded article after vacuum forming and the injection molding in the insert molding or on the pattern having elevations and depressions of the thermoject molded article after injection molding in the thermoject molding, and the decorative film for molding can be advantageously used for various type of insert molded articles and thermoject molded articles.

1. A decorative film for molding having bossed portions on a base sheet, wherein an area of an entire bossed portions is 45% or smaller of an area of an entire face of the base sheet, and an area of a single bossed portion is 2 mm² or smaller.

2. A decorative film for molding according to claim 1, wherein a distance between bossed portions is 0.2 mm or greater.

3. A decorative film for molding according to claim 1, wherein the bossed portions are formed with a cured product obtained by crosslinking a resin composition curable with an ionizing radiation.

4. A decorative film for molding according to claim 3, which is obtained by laminating a colored layer, an adhesive layer and a backer layer to a back face of the base sheet successively in this order.

5. A decorative film for molding according to claim 2, which is obtained by laminating a colored layer, an adhesive layer and a backer layer to a back face of the base sheet successively in this order.

6. A decorative film for molding according to claim 1, which is obtained by laminating a colored layer, an adhesive layer and a backer layer to a back face of the base sheet successively in this order.
